(19) United States
(12) Patent Application Publication
(10) Pub. No.: US 2017/0157979 A1
(43) Pub. Date: Jun. 8, 2017

(54) MOUNTING BRACKET FOR A WHEEL COVER

(71) Applicant: Real Wheels Cover Company, Inc., Gurnee, IL (US)

(72) Inventors: John Polka, Gurnee, IL (US); Ronald Tushner, Lindenhurst, IL (US)

(73) Assignee: Real Wheels Cover Company, Inc., Gurnee, IL (US)

(21) Appl. No.: 14/957,926

(22) Filed: Dec. 3, 2015

(51) Int. Cl. B60B 7/06

(52) U.S. Cl. CPC B60B 7/068; B60B 2320/10; B60B 2900/351; B60B 2900/572

(57) ABSTRACT

A structure and method for securing an aerodynamic cover to a wheel of a roadway vehicle comprises fitting keyhole openings in a base plate or sectors thereof about at least some of the lug nuts holding the wheel to the hub of the vehicle axle, and rotating the base plate to engage portions thereof beneath or behind the lug nut heads or flanges, A locking bar is attached to the base plate or one of the sectors to prevent reverse rotation thereof. The wheel cover is placed over the wheel, engaged at the cover's periphery against the rim of the wheel, and attached to upstanding brackets carried by the base plate or sectors.

### FIELD OF THE INVENTION

The present invention is in the field of mounting systems and brackets for carrying decorative and aerodynamic wheel covers on trucks and vans.

### BACKGROUND OF THE ART

Decorative and functional wheels and wheel covers for roadway vehicles are used to customize and improve the appearance and functionality of roadway vehicles including automobiles, vans, and small and large trucks. Wheel covers enclose the hubs and wheels of such vehicles, but mounting them securely on the many different fashions of wheels used each model year—both for original vehicle equipment and for after-market wheels—is problematic. Covers and mounting hardware must be designed and made for each vehicle which is sold with enough of a given wheel design to make a worthwhile market for such special wheel covers.

### SUMMARY OF THE INVENTION

It is an object of this invention to provide a convenient and durable mounting system for wheel covers adapted for instance to fit over the front wheels of, for just one instance, the Ford Motor Company's Transit Van, inwardly of the rims on which the tires are mounted.

In accordance with principles of the invention, in one form, a circular base plate has a circle of keyhole apertures corresponding to the threaded bolts or studs and lug nuts holding the wheel to a hub of the vehicle. The base plate fits over and passes beyond each of the bolt heads or lug nuts without removing or loosening such bolts or nuts. Rotating the base plate about the centerline of the wheel engages the narrower portions of each keyhole aperture beneath or behind the heads or flanges provided on each of the corresponding bolts or lug nuts, securing the base plate to the wheel, in a twist and lock fashion. This system works well with both conical bolt and lug nut seats and with spherical or ball seats. Alternatively, portions of the circular base plate, as two or three sectors each fitting over just two of the lug nuts and each sector carrying a mounting bracket, can be used. Rotation of the base plate or sectors in the reverse direction is prevented by an anti-rotation or securement plate attached to the base or at least one of the sectors and extending over at least one of the larger portions of the keyhole apertures. Upstanding brackets carried by the base plate or each sector used will support and engage a center portion of the wheel cover, which is connected as by screws thereto.

### BRIEF DESCRIPTION OF THE DRAWINGS

FIG. 1 is a perspective view of a mounting bracket of one form of the present invention installed on and affixed to a wheel of a vehicle.

FIG. 2 is a side sectional view through a stud and lug nut affixing a wheel to a hub, with the base mounting plate or sector fitted on the base of the lug nut beneath a surrounding flange of the nut.

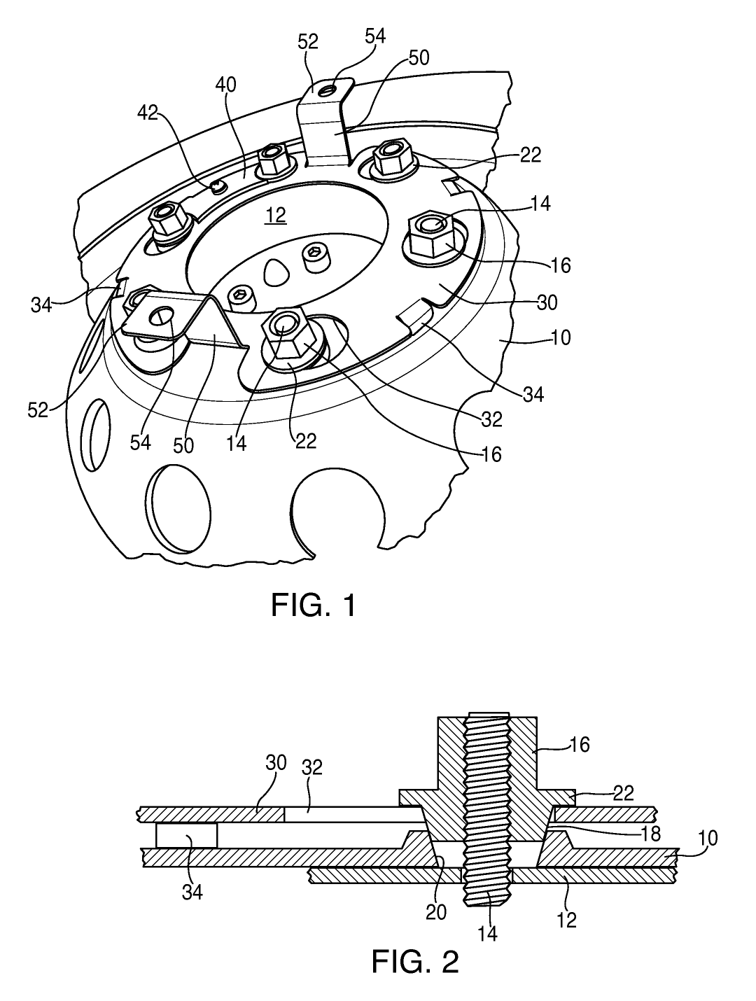

### THE PREFERRED EMBODIMENTS

For use with one form of the invention, a roadway wheel 10 is carried on a hub 12, which has a circle of threaded wheel attachment studs 14 extending from the hub and through apertures in the wheel. Lug nuts 16 are screwed onto the studs 14 so that lower, conical portions 18 engage the wheel 10 at tapered surfaces 20 formed therein. Each lug nut 16 has either a lower peripheral flange 22 formed on its base above the conical portion 18 or a head whose lower portion is sized sufficiently to capture a base plate, as set forth herein.

To attach a wheel cover (not shown) to the wheel 10, a base plate 30 is formed, in one embodiment, as a circular plate with a series of keyhole apertures 32 formed inwardly of its periphery, corresponding to the size and locations of the studs 14 and lug nuts 16, or corresponding bolts where those are used. Each aperture 32 has a wider first portion that passes over and past the head of the nut 16 and any flange 22 on the lug nut 16, and a narrower second portion that is captured beneath the head or flanges 22 of the lug nuts 16 when the base plate is rotated into a final position. Three or more stand-off tabs 34 are formed and bent from the periphery of the base plate 30 to space the base plate 30 from the surface of the center part of the wheel 10, providing some rigidity yet leaving some spring in the base plate to assist in maintaining the plate 30 in its rotated position on the studs 14 and lug nuts 16 or similar bolts.

To lock the base plate 30 in its position securely on the wheel 10, a locking bar 40 is attached to the outer surface of the base plate 30 between two of the apertures 32, as via a screw or bolt 42 passing through the bar 40 and engaged with a threaded hole in the base plate 30. The bar 40 engages at least one of the bolts or lug nuts 16 or a flange 22 thereof over the wider portion of the keyhole slot 32, This bar 40 prevents the base plate 30 from rotating and becoming disconnected from beneath the lug nuts 16, thus avoiding loss of the wheel cover.

Upstanding mounting posts 50, 50 extend from the base plate 30 and have co-planar top surfaces 52 with threaded apertures 54 formed therein for receiving attachment screws passing through the wheel cover (not shown).

An alternative embodiment of the invention uses smaller portions or sectors of the base plate to attach to the lug nuts at evenly spaced intervals about the wheel and to carry the upstanding mounting posts, one per sector. This makes mounting the support brackets to the wheel a bit easier while being just as secure.

In use, once the wheel 10 is securely mounted on the hub 12 of the vehicle, via the studs 14 and lug nuts 16, or similar bolts, the base plate 30 is positioned with the larger portions of its keyhole apertures 32 over the circle of lug nuts 16. It is then pressed into positon with bottoms of the tabs 34 set against the surface of the wheel 10, and the base plate 30 then is rotated so that the smaller portions of the apertures 32 are captured beneath the flange 22 or a head of each lug nut 16 or bolt. The locking bar 40 is then attached to the face of the base plate 30 with the screw 42, with one end of the bar 40 preventing reverse rotation of the base plate 30. The bar preferably has a second end bearing against an adjacent nut, flange, or bolt head. Then the wheel cover (not shown) is placed over the wheel 10 extending to the rim on which the tire is mounted, over the hub 12, and over the mounting brackets 52. It is secured to the brackets 52 by any suitable means, such as screws passing through the cover and into the threaded apertures 54.

Many variations may be made in the invention as shown and in its manner of use, without departing from the principles of the invention as described herein and/or as claimed as my invention. For instance, bolts can be used to affix the wheel to the hub, and a mounting plate can be fitted around such bolt heads in the same manner as the lug nuts shown here. Ball seats for the lug nuts or bolts are equally useable in this invention. Sectors of the base plate can be used rather than an entire circular base plate. These and other minor variations will not avoid use of the invention.

I claim as my invention:

1. A mounting bracket system for securing a wheel cover to a wheel of a vehicle, the wheel being mounted on a hub of the vehicle via bolts or lug nuts about a rotational center of the wheel, each of the bolts or lug nuts when mounted on the wheel having space between a head or circumferential flange thereof and the wheel surface, the bracket system comprising:
a base plate with apertures formed therein with first portions adapted to fit over said wheel about said center thereof and about each of the bolts or lug nuts fastening same to the hub of the vehicle,
the apertures in the base plate having narrower portions adapted to be captured beneath the heads or flanges of the bolts or nuts when the base plate is rotated into a final position; and
at least two upstanding mounting tabs attached to the base plate and extending away from the wheel and hub of the vehicle for cooperating with the wheel cover and retaining it in position over the wheel.

2. The mounting bracket system defined in claim 1, further comprising an anti-rotation bar fitting over and removably affixed to part of the base plate and a wider portion of one of the apertures therein and against an adjacent bolt or nut when the base plate is installed on the wheel, whereby to prevent the base plate from disconnecting from the bolts or nuts and wheel.

3. The mounting bracket system defined in claim 1, further comprising stand-off tabs projecting from the base plate and into contact with the wheel surface when the base plate is installed on the wheel, whereby to stiffen the base plate and ensure its contact with the bolts or nuts.

4. A method of improving the appearance and functionality of a vehicle wheel by providing a mounting means for a wheel cover therefor, comprising the steps:
affixing a base plate to the wheel surrounding the wheel's center of rotation, the base plate fitting over and about at least some of the bolts or nuts affixing the wheel to a hub of the vehicle; and
affixing said cover to mounting brackets carried by the base plate, the cover resting on a rim of the wheel and covering the base plate and hub of the vehicle.

5. The method of claim 4, wherein the step of affixing the base plate to the wheel includes rotating the base plate so as to engage portions of the plate behind a head or flange of the lug nuts or bolts.

6. The method of claim 4, further comprising a step of securing the base plate against reverse rotation after it is installed on the wheel.
